(19) United States
(12) Patent Application Publication
(10) Pub. No.: US 2008/0151946 A1
(43) Pub. Date: Jun. 26, 2008

(54) Monolithic Solid State Laser Apparatus

(75) Inventors: Nissim Zafrani, Bnei Brak (IL); Yuval Artstein, Tel-Aviv (IL)

Correspondence Address: OBLON, SPIVAK, MCCLELLAND MAIER & NEUSTADT, P.C., 1940 DUKE STREET, ALEXANDRIA, VA, 22314, US

(73) Assignee: ELBIT SYSTEMS ELECTRO-OPTICS ELOP LTD., Rehovot (IL)

(21) Appl. No.: 11/817,578

(22) PCT Filed: Feb. 27, 2006
(86) PCT No.: PCT/IL06/00258

§ 371 Date: Aug. 31, 2007

(30) Foreign Application Priority Data
Mar. 1, 2005 (IL) 167174

(51) Int. Cl. H01S 3/06; H01S 3/08

(52) U.S. Cl. 372/11; 372/43.01; 372/10; 372/75; 372/36

(57) ABSTRACT

There is provided a solid-state laser apparatus, including a solid-state active element (4) having major surfaces and first and second edges (10,12) oppositely disposed to each other, the first edge (10) being flat and the second edge (12) being constituted by first and second perpendicularly disposed surfaces (12) or having first and second perpendicularly disposed surfaces (12) located adjacent to the second edge, a back reflector (16) and an output coupler (18) located at, or adjacent to, the first edge (10). Light induced in the cavity forms two parallel beams passing therethrough, by means of a first beam which is reflected by the back reflector (16) towards a first of the perpendicularly disposed surfaces and being folded to pass on to the second surface, to be further folded and to proceed towards the first edge (10). A saturable absorber (14) may be attached to the first edge (10).

### FIELD OF THE INVENTION

The present invention relates to optical devices and more particularly the invention is concerned with a solid-state laser apparatus.

### BACKGROUND OF THE INVENTION

Solid-state lasers, which comprise separate optical elements that require alignment accuracy in the range of several arc seconds, are well known. A larger misalignment causes a gradual reduction of laser output energy until finally lasing stops. The optical elements generally include an active laser element, such as a laser rod or a laser slab, a back mirror, and a partially reflective output coupler, and may or may not include a Q-switch. The high sensitivity to misalignment of parts causes difficulties in manufacturing and in robustness in hard environmental conditions. The problem is more severe in cases where the laser functions in high repetition rates and thermal effects in the active element make its refractive index inhomogeneous, thus altering the course of light within the element. This causes the laser to become misaligned in the course of operating. Further disadvantages include complicated mounting mechanisms and lack of compactness, and high part costs.

A large amount of effort has been invested in overcoming the above-mentioned disadvantages. U.S. Pat. No. 5,847,871 discloses an assembly that combines two or three optical functions into a single optical element, namely, the functions of retro-reflection, of saturable absorption and of polarization rotation. U.S. Pat. No. 6,526,088 makes use of a corner prism as a back reflection mirror in a laser with a lamp pump.

### DISCLOSURE OF THE INVENTION

It is therefore a broad object of the present invention to provide a solid-state laser apparatus which ameliorates the disadvantages of the prior art solid-state lasers, and provides a solid-state laser apparatus utilizing an optically active element having at least one flat edge and two perpendicularly disposed surfaces at its other edge or adjacent thereto.

It is a further object of the invention to provide a solid-state laser apparatus comprising an active element in the form of a slab wherein the slab is pumped by one or more diode bars or lamps located along at least one side of the slab.

It is still a further object of the invention to provide a solid-state laser apparatus, which eliminates adverse thermal effects created at high repetition rates.

In accordance with the invention, there is therefore provided a solid-state laser apparatus, comprising a solid-state active element having major surfaces and first and second edges oppositely disposed to each other; at least said first edge being flat and said second edge being constituted by first and second perpendicularly disposed surfaces or having first and second perpendicularly disposed surfaces located adjacent to said second edge, and a back reflector and an output coupler located at, or adjacent to, said first edge, wherein light induced in said cavity forms two parallel beams passing therethrough, by means of a first beam which is reflected by said back reflector towards a first of said perpendicularly disposed surfaces and folded thereby, to pass on to said second surface, to be further folded thereby and proceed towards said first edge.

### BRIEF DESCRIPTION OF THE DRAWINGS

The invention will now be described in connection with certain preferred embodiments with reference to the following illustrative figures, so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic drawing of a first embodiment of a solid-state laser apparatus according to the present invention;

FIGS. 2 to 5 are schematic drawings of further embodiments of the present invention;

FIG. 6 is an enlarged perspective view of the prism utilized in FIG. 5;

FIG. 7 is a schematic drawing of still a further embodiment of the present invention;

FIGS. 8 and 9 schematically illustrate the laser apparatus according to the present invention, as coupled to one or more heat sinks;

FIGS. 10 to 13 schematically illustrate further embodiments of the present invention, and

FIGS. 14 and 15 schematically illustrate a further way for coupling pumping light into the active element of the laser apparatus.

### DETAILED DESCRIPTION OF PREFERRED EMBODIMENTS

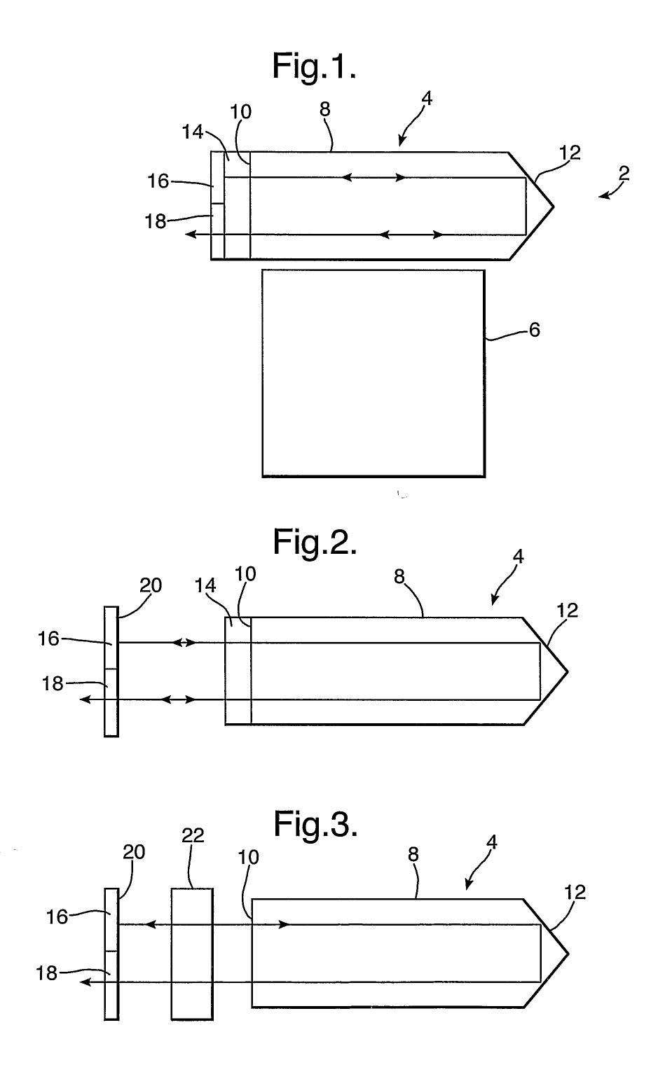

In FIG. 1 there is illustrated an embodiment of a solid-state laser apparatus 2 composed of an active element 4 and one or more bars 6 of pumping diodes or lamps. The active element 4 is made in the form of a slab 8 having major surfaces and at least one flat edge 10 and an opposite edge having two perpendicular surfaces shaped as a rooftop 12. As seen, the bar 6 is located along one of the major surfaces of the active element 4, for pumping radiation or light into the active element 4. To the latter there is attached at the flat edge 10, a saturable absorber 14 and, in turn, the exposed surface of the absorber 14 is partly coated with a high reflective layer 16 and partly coated with a partially reflective layer 18. The high reflective layer 16 acts as a back mirror, while the partially reflective layer 18 acts as an output coupler. Thus, this embodiment forms a single monolithic optical element constituted by an active element 4, an optically coupled saturable absorber 14, and a reflector and a partial reflector, constituted by layers 16 and 18, not requiring mounting assemblies. The active element 4 may preferably be made of Nd:YAG, Yb:YAG, Er:Glass, Er:Yb:Glass, however, per-se known materials can just as well be used, e.g., YSGG, YSAG, GSAG, GSGG. GGG or GIGG. Advantageously, for effecting satisfactory induction of light into the slab 8, the major surface adjacent to the bar 6 is coated with anti-reflective coating for transmitting radiation or light induced therein, and the oppositely located second major surface reflects light back into the body of the active element.

As can be understood, in the embodiment of FIG. 1 the slab 8 is side-pumped from one side so that a thermal gradient occurs in the direction of pumping. This induces a gradient in the refraction index, which, in turn, induces a deflection of light passing perpendicular to that direction, or a thermal wedging. This deflection is compensated for by the reflection of light at the end of the slab 8 and by the double parallel pass of light through the slab, as indicated by the arrows. The slab 8 is side-pumped by a pump diode bar or bars or by a flash lamp 6. While FIG. 1 illustrates pumping of the slab 8 from one lateral side thereof, it is, of course, possible to arrange one or more bars 6 at each of the two or more of the lateral sides of the slab 8.

Referring to FIG. 2, there is shown a modification of the embodiment of FIG. 1, wherein the reflective layer 16 and partially reflective layer 18 are applied to a glass slide 20, which is located at a distance from the saturable absorber 14. As seen, the border between the reflective layers 16 and 18 is disposed substantially opposite to the apex of the rooftop 12 of the slab 8.

FIG. 3 illustrates still a further modification, in which instead of the saturable absorber 14, there is provided a Q-switch 22 interposed between the spaced-apart glass slide 20 carrying the reflective layers 16 and 18 and the flat edge 10 of the slab 8. Examples of active Q-switches that can be used are acousto-optic, electro-optic, mechanical or Frustrated Total Internal Reflection (FTIR).

The reflective layer 16 and the partially reflective layer 18 can be applied to the absorber 14, to the glass slide 20 or to the Q-switch 22, by any known manner, including by coating.

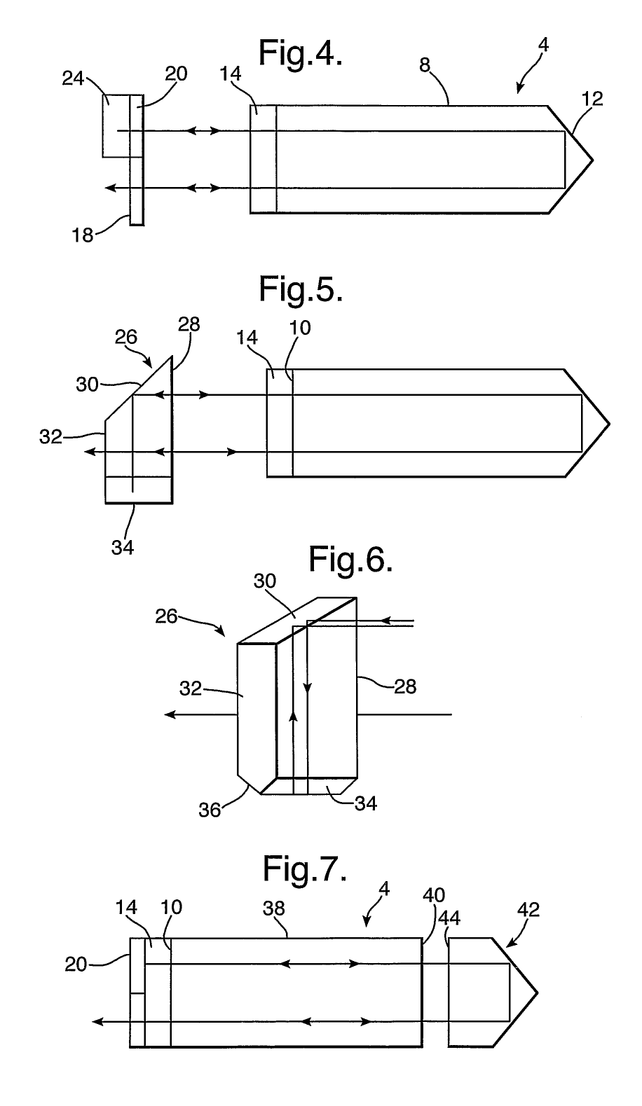

Turning to FIG. 4, there is illustrated an embodiment similar to that of FIG. 2, wherein to the outside surface of the glass slide 20 there is attached a porro reflector 24 replacing the high reflection coating layer 16. A further embodiment illustrated in FIG. 5 includes a folding prism 26, also shown for better understanding in FIG. 6, replacing both the high and partially reflecting layers 16, 18. The prism 26 has five optical surfaces. A first surface 28 is coated with an anti-reflective coating. A second surface 30 is at an angle to the first surface 28, so that light entering through part of the first surface 28 is reflected by total internal reflection by the second surface 30. A third surface 32 is opposite to the first surface and is coated with a partially reflective coating, and partially reflects the light that passes through the first surface 28 and does not impinge on the second surface 30. The prism 26 is disposed with its surface 28 facing the flat edge 10 of the slab 8, to form a resonant cavity with the third surface 32 functioning as an output coupler and fourth and fifth surfaces 34, 36, as a porro back mirror.

In FIG. 7, there is illustrated a further embodiment according to the present invention in which the active element 4 is configured as a slab 38 with two flat edges 10 and 40 and there is provided a porro prism 42 positioned adjacent to slab 38 with its flat surface 44 facing edge 40 of the slab. The porro prism 42 just as the rooftop 12 configuration, provides total internal reflection of incident light rays emitted by the slab 8. The slab 8 is pumped by a diode bar or bars or by one or more pump lamps 6, all of which are disposed along the side surfaces of the slab 38. Instead of the porro prism 42, a corner prism (not shown) could also be utilized.

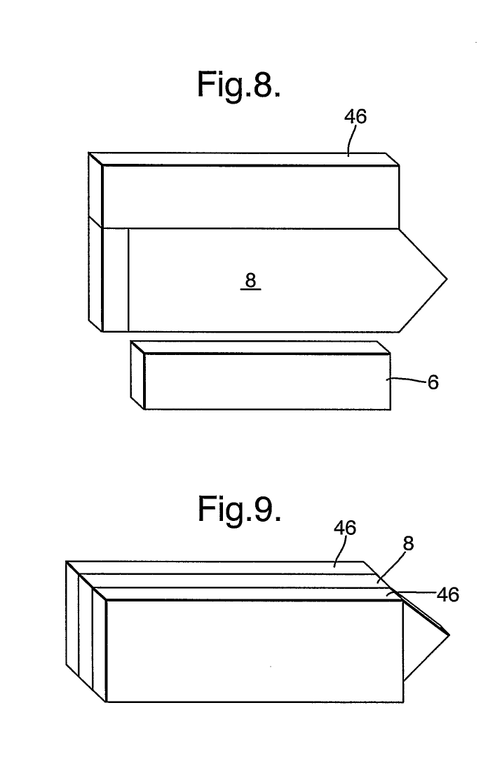

Since laser apparatuses of the present invention usually require dissipation of the generated heat, the active element 4 can be thermally coupled to one or more heat sinks 46, as illustrated in FIGS. 8 and 9. FIG. 8 shows an embodiment wherein the slab 8 is thermally coupled at the major surface opposite to the pumping bar 6 to a heat sink 46. This forces a unidirectional heat flow toward the heat sink so that a temperature gradient is created in that direction. As a result a refraction index gradient is developed in the same direction. The light making a double pass through the slab is deflected in both passes, with one deflection compensating for the other. In the embodiment shown in FIG. 9, the slab 8 is thermally coupled at its two sides adjacent to the side of the pumping bar 6. It should be understood that heat sinks can be thermally coupled to the slab 8, as shown in both of FIGS. 8 and 9.

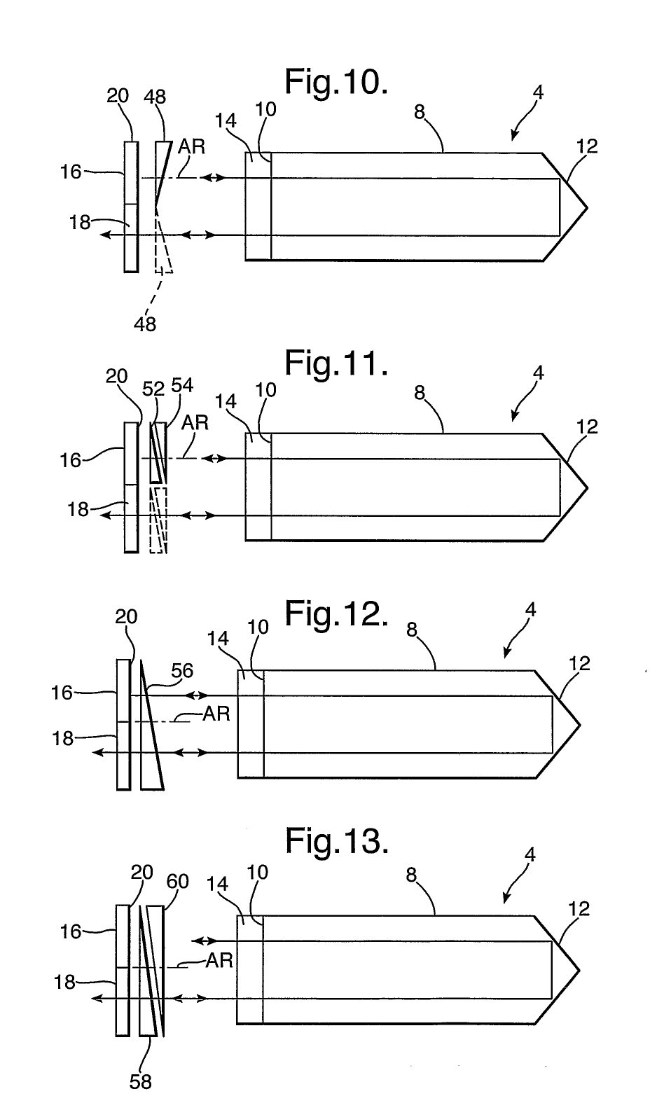

FIGS. 10 to 13 illustrate several possible embodiments for alignment in the laser resonator. Seen in FIG. 10 is an optical wedge 48 having an axis of rotation AR, disposed between the flat edge 10 of the slab 8 and selectively one of the highly reflective layer 16 of partially reflective layer 18, as indicated by the broken lines of the wedge 48′. The wedge 48 deflects one of the beams relative to the other for correcting any deviation from parallelism, or for introducing a predetermined deflection of a beam. In FIG. 11, there is shown a pair of optical wedges 52, 54 positioned in the same location as wedge 48. This arrangement of wedges facilitates deflection in one predetermined plane only. The modification of FIG. 12 provides a single optical wedge 56 extending across the two layers 16, 18. The wedge 56 deflects the two beams together relative to the slab 8. Finally, in FIG. 13 there is depicted a configuration in which there are disposed two optical wedges 58, 60, both extending across the two layers 16, 18. By means of these wedges, misalignment of the slab with respect to the back reflector and output coupler can be corrected.

As can be understood, the embodiments of FIGS. 10 to 13 are applicable in embodiments in which the layers 16, 18 are disposed in a spaced-apart relationship to the flat edge 10, e.g., as shown in FIGS. 2 to 6 and are not applicable to the embodiments of FIGS. 1 and 7, wherein the layers 16, 18 are applied on the slab 8.

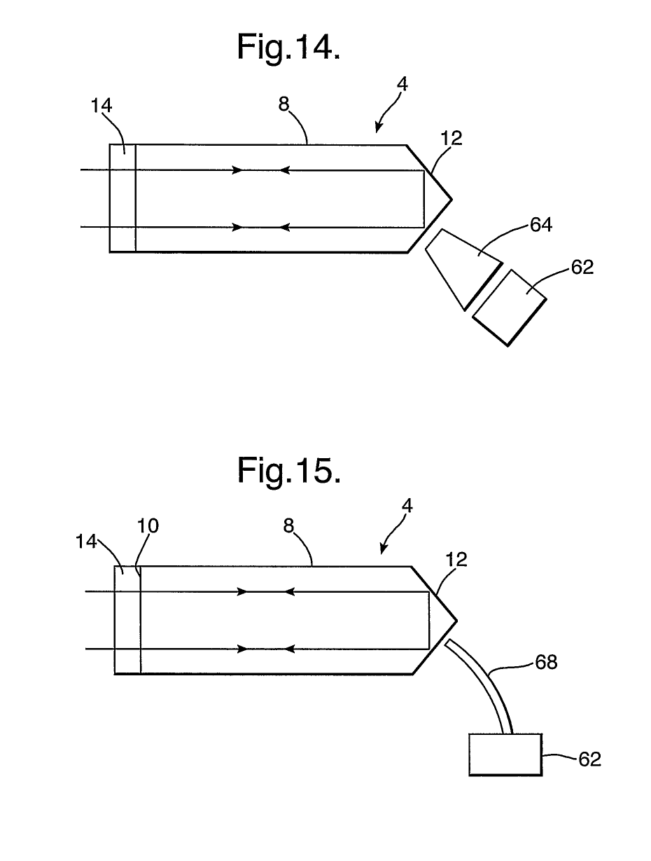

FIGS. 14 and 15 show an alternative way of coupling the pumping radiation into the active element, through one of its perpendicular surfaces. This way may be advantageous especially when a high pumping flux is desired for efficient excitation of the active element, for example, in Yb:YAG lasers.

In FIG. 14 the pumping radiation or light from a diode source 62 is directed by a light guide 64 into one of the surfaces of the rooftop 12. The radiation or light coupled into the active element 4 is reflected from the major surfaces 66 by total internal reflection. The reflection can be enhanced by applying reflective coatings on the major surfaces.

In FIG. 15 a similar pumping scheme is illustrated with the diode source 62 coupled to a light guide in the form of an optical fiber 68 for directing the light towards one surface of the rooftop 12. As can be understood, in the arrangements of FIGS. 14 and 15 the pumping radiation can be directed through both perpendicular surfaces of the rooftop 12.

The above-described present invention can effectively be utilized, inter alia, with designators for homing heads, range finders and markers for military and civilian purposes.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A solid-state laser apparatus, comprising:
a solid-state active element having major surfaces and first and second edges oppositely disposed to each other;
at least said first edge being flat and said second edge being constituted by first and second perpendicularly disposed surfaces or having first and second perpendicularly disposed surfaces located adjacent to said second edge, and
a back reflector and an output coupler located at, or adjacent to, said first edge,
wherein light induced in said cavity forms two parallel beams passing therethrough, by means of a first beam which is reflected by said back reflector towards a first of said perpendicularly disposed surfaces and folded thereby, to pass on to said second surface, to be further folded thereby and proceed towards said first edge.

2. The laser apparatus as claimed in claim 1, wherein said active element is configured as a slab.

3. The laser apparatus as claimed in claim 1, wherein said first and second perpendicularly disposed surfaces are part of a porro prism or corner prism.

4. The laser apparatus as claimed in claim 1, further comprising a Q-switch located at, or adjacent to, said first edge.

5. The laser apparatus as claimed in claim 4, wherein said Q-switch is a saturable absorber.

6. The laser apparatus as claimed in claim 5, wherein said saturable absorber is optically contacted or bonded to the first edge of said active element.

7. The laser apparatus as claimed in claim 1, wherein said back reflector and output coupler are constituted by a highly reflective means and a partially reflective means attached to said saturable absorber.

8. The laser apparatus as claimed in claim 1, wherein said back reflector and output coupler are constituted by a highly reflective layer and a partially reflective layer coated on said first edge.

9. The laser apparatus as claimed in claim 1, wherein said back reflector and output coupler are constituted by a highly reflective means and a partially reflective means on a common optical element.

10. The laser apparatus as claimed in claim 9, wherein said highly reflective means is a porro reflector.

11. The laser apparatus as claimed in claims 9, wherein said common optical element is a prism having a first surface coated with anti-reflection material, a second surface disposed at an angle to said first surface, so that light entering through part of said first surface is reflected off said second surface, by total internal reflection, towards third and fourth surfaces constituting said porro reflector, and a fifth surface disposed opposite to said first surface and being coated with a partially reflective coating, constituting said output coupler.

12. The laser apparatus as claimed in claim 4, wherein said back mirror and output coupler are constituted by a highly reflective means and a partially reflective means coated on a surface of said Q-switch.

13. The laser apparatus as claimed in claim 1, further comprising at least one pumping diode bar or lamp located adjacent to at least one major surface of said active element.

14. The laser apparatus as claimed in claim 1, further comprising at least one heat sink thermally coupled to at least one of said major surfaces of said slab.

15. The laser apparatus as claimed in claim 13, wherein said first major surface of the active element is coated with anti-reflective coating for transmitting light induced therein, and an oppositely located second major surface reflecting light back into the active element.

16. The laser apparatus as claimed in claim 1, further comprising an optical wedge or a pair of optical wedges disposed between said first edge and said highly reflective layer or partially reflective layer, or extending across both highly reflective and partially reflective layers.

17. The laser apparatus as claimed in claim 1, further comprising at least one pumping diode coupled to a light guide located adjacent to at least one of said perpendicular surfaces.

18. The laser apparatus as claimed in claim 17, wherein at least one of said major surfaces of the active element is coated with reflective coating for reflection of pumping radiation into the active element.
